(19) United States
(12) Patent Application Publication
(10) Pub. No.: US 2023/0245039 A1
(43) Pub. Date: Aug. 3, 2023

(54) TRACKING SYSTEM FOR FOOD COMMODITY SUPPLY CHAIN

(71) Applicant: Microsoft Technology Licensing, LLC, Redmond, WA (US)

(72) Inventors: Vaishnavi NATTAR RANGANATHAN, Woodinville, WA (US); Peeyush KUMAR, Seattle, WA (US); Ali SAFFARI, Seattle, WA (US); Ranveer CHANDRA, Kirkland, WA (US); Michael McNab BASSANI, Seattle, WA (US); Jessica Ayeley QUAYE, Cambridge, MA (US); Krishna Kant CHINTALAPUDI, Redmond, WA (US); Tusher CHAKRABORTY, Bangalore (IN)

(73) Assignee: Microsoft Technology Licensing, LLC, Redmond, WA (US)

(21) Appl. No.: 17/662,820

(22) Filed: May 10, 2022

(30) Foreign Application Priority Data
Feb. 3, 2022 (IN) 202241005836

(51) Int. Cl. G06Q 10/08; H04W 4/029; H04W 4/02; H04W 4/80; G01S 19/01

(52) U.S. Cl. CPC G06Q 10/0833; H04W 4/029; H04W 4/027; H04W 4/80; G01S 19/01

(57) ABSTRACT

A tracking system for a food commodity supply chain includes a tracking device and a computing device. The tracking device is mounted to a conveyance structure that is configured to receive a unit load of a food commodity. The tracking device includes a sensor to track an environmental condition of an environment of the tracking device while the tracking device is traveling along the food commodity supply chain. The computing device is configured to receive an environmental value of the environmental condition sensed by the sensor, process the environmental value to determine whether the environmental condition is within a predetermined environmental range, and transmit an alert when the environmental condition falls outside the predetermined environmental range. The alert includes a suggested interventive action based on the environmental condition that falls outside the predetermined environmental range.

### BACKGROUND

Increasing emphasis is being placed upon accountability and sustainability of food commodities that travel through supply chains to reach end consumers. Consumers are coming to demand that the items they purchase are available at the peak of freshness and have been produced in a socially, environmentally, and economically sustainable manner. For example, every product obtained through a supply chain carries with it a carbon footprint, water usage, raw material usage, etc. that were required to produce and transport the product to the consumer. Opportunities exist for technical solutions to be developed that enable consumers, businesses, and regulatory agencies alike to gain insights as to the sustainability, quality, and nutritional value of food commodities, and particularly produce and other perishable food, passing through such supply chains, and deepen understanding of how food commodities move through supply chains to technologically enable increased accountability for the handling of those food commodities throughout the supply chains.

### SUMMARY

To address the issues discussed herein, a tracking system for a food commodity supply chain is provided. According to one aspect, the tracking system comprises a tracking device and at least one computing device. The tracking device is configured to be mounted to a conveyance structure configured to receive a unit load of a food commodity traveling along the food commodity supply chain. The tracking device includes at least one sensor configured to track at least one environmental condition of an environment of the tracking device while the tracking device is traveling along the food commodity supply chain. The at least one computing device has at least one processor, which is configured to receive an environmental value of the at least one environmental condition sensed by the at least one sensor, and process the environmental value to determine whether the at least one environmental condition is within a predetermined range. When the at least one environmental condition falls outside the predetermined range, the processor is configured to transmit an alert, and the alert includes a suggested interventive action based on the at least one environmental condition that falls outside the predetermined range.

In some configurations, the tracking system includes a communication hub configured to receive, store, and transmit data from the tracking device. The communication hub includes at least one of a Satellite Communications (SATCOM) module and a terrestrial communications module. The communication hub is configured to switch between the SATCOM module and the terrestrial communications module in accordance with signal conditions.

In some configurations, the tracking system includes a location determination subsystem configured to determine a location of the tracking device as it travels along the food commodity supply chain. The location determination subsystem includes at least one of a SATCOM module and a terrestrial communications module. The SATCOM module includes a Global Positioning System (GPS) element configured to determine GPS coordinates of the tracking device, and the terrestrial communications module is configured to exchange signals with terrestrial access points towers.

In some configurations, the tracking device includes an Inertial Measurement Unit (IMU) module configured to determine IMU values of the tracking device. The processor is configured to receive IMU values of the tracking device, and process the IMU values to determine whether the IMU values are within a predetermined range. When the IMU values fall outside the predetermined range, the processor is configured to transmit an alert.

In some configurations, the sensor is selected from the group consisting of temperature sensor, humidity sensor, gas sensor, air quality sensor, and light sensor, and the system also includes at least one pressure sensor configured to measure a load placed on the conveyance structure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram of a tracking system for a food commodity supply chain according to a first embodiment.

FIG. 2 is an illustration of an implementation of the tracking system of FIG. 1.

FIG. 3 is an illustration of an example scenario in which the tracking system of FIG. 1 is implemented in a food supply chain.

FIG. 4 is an illustration of hybrid network connectivity of the tracking system of FIG. 1.

FIG. 5 is a schematic diagram of a tracking system for a food commodity supply chain according to a second embodiment.

FIG. 6 is a flowchart of a method for tracking a food commodity through a supply chain according one example configuration of the present disclosure.

FIG. 7 is an example computing system according to one implementation of the present disclosure.

### DETAILED DESCRIPTION

As products move along supply chains, they may be exposed to various conditions in the environment. However, such information frequently remains unknown, as tracking and measuring the conditions experienced by a commodity in transit can be difficult to achieve. While many commodities are unaffected by fluctuations in temperature, humidity, air quality, and the like, such conditions can be detrimental to the quality of other products. The issue of tracking environmental conditions along the supply chain is particularly impactful for perishable commodities, such as produce, as information that is lost between the harvest stage and the distribution stage may lead to the premature ripening of the produce and thus a decrease in quality, nutritional value, and/or shelf-life. This information loss can also lead to food loss when the environmental conditions result in significant decline in quality that renders the produce unfit for sale. Further, the failure to maintain stable conditions during transport and storage can lead to significant nutrient loss, which goes largely unaccounted for in conventional food commodity supply chains. While some solutions to collecting environmental data at farming locations and storage facilities have been implemented, a technical challenge exists in effectively tracking the environmental conditions experienced by commodities as they move along the supply chain.

Utilizing the systems and methods described herein, environmental conditions of commodities can be tracked and measured as the commodities are transported along a supply chain. For example, in a produce supply chain, changes in conditions such as temperature, humidity, air quality, light, and exposure to gases can lead to changes in flavor or texture of the produce, as well as expedited ripening. Tracking and measuring such information can be used to reduce loss, maintain quality and nutritional value, and increase the sustainability of supply chain operations, as described below. Although described primarily in the context of food supply chains, the systems and methods described herein also have applicability to commodities transported in unit loads, such as electronic equipment and devices, medical supplies, pharmaceuticals, personal hygiene products, and household cleaning supplies.

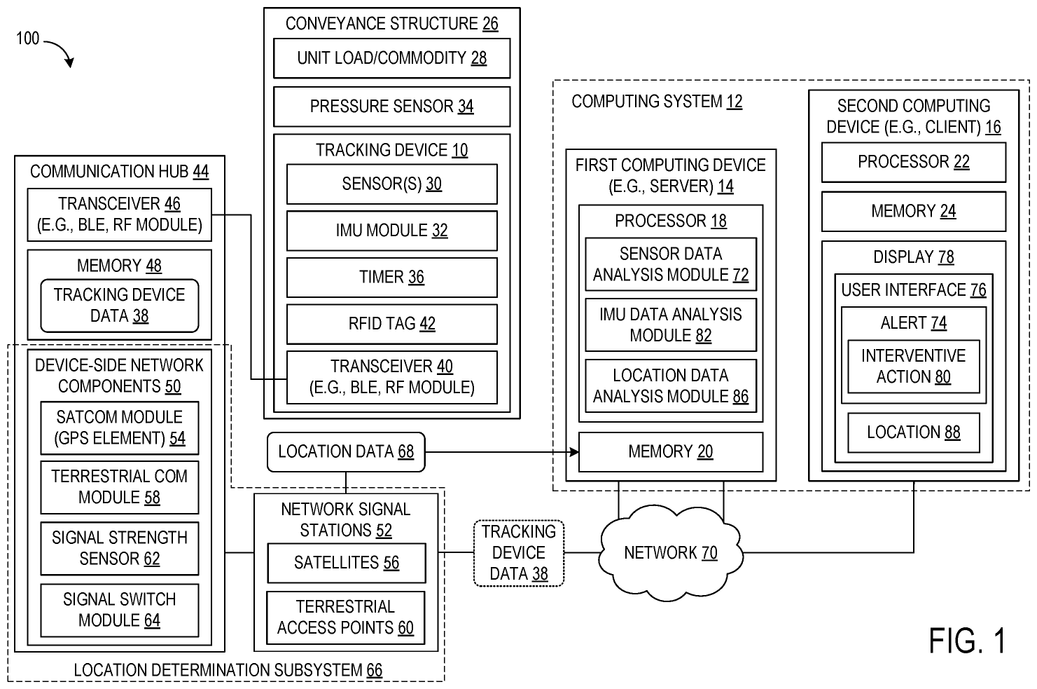

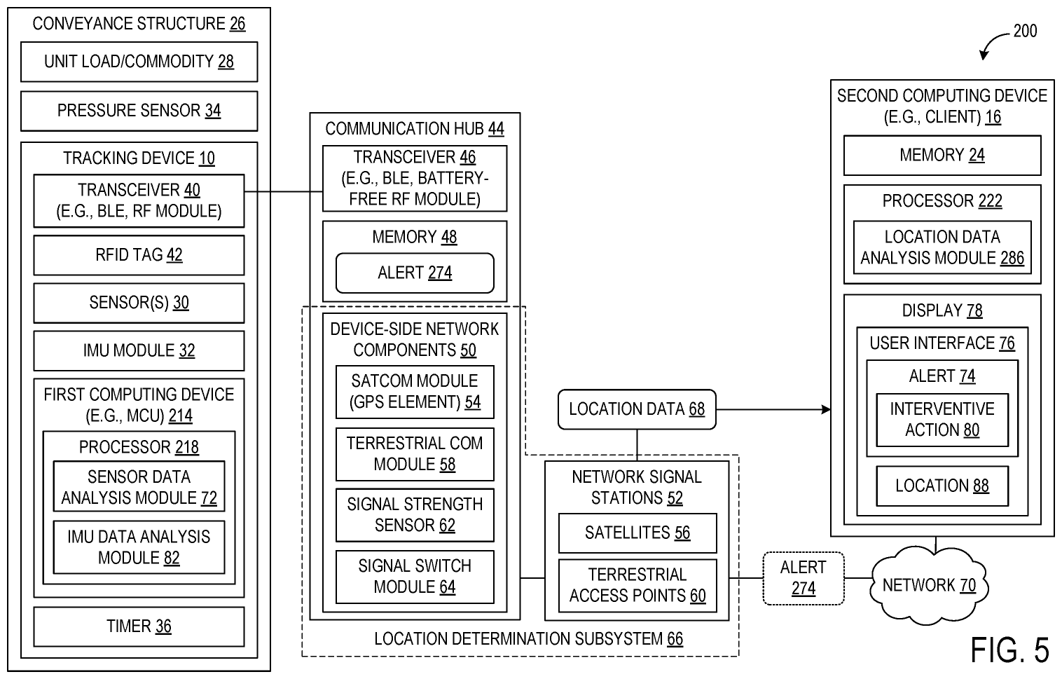

To address the above identified issues, a tracking system 100 for a food commodity supply chain is provided. Referring initially to FIG. 1, a first embodiment of the tracking system 100 includes a tracking device 10 and a computing system 12 that includes at least one computing device. The computing system 12 is illustrated as including a first computing device 14 including a processor 18 and memory 20, and a second computing device 16 including a processor 22 and memory 24. The illustrated implementation is exemplary in nature, and other configurations are possible. In the description of FIG. 1 below, the first computing device will be described as a server computing device 14 and the second computing device will be described as a client computing device 16, and respective functions carried out at each device will be described. It will be appreciated that in other configurations, such as the tracking system 200 described below with reference to FIG. 5, the first computing device could be a computing device other than server computing device 14. In some configurations, the computing system 12 may include a single computing device that carries out the salient functions of both the server computing device 14 and client computing device 16. In other alternative configurations, functions described as being carried out at the server computing device 14 may alternatively be carried out at the client computing device 16 and vice versa.

Continuing with FIG. 1, the tracking device 10 is configured to be mounted to a conveyance structure 26 that is used to transport and/or store a food commodity as it moves along the supply chain. The conveyance structure 26 may be a box, crate, carton, pallet, or any other suitable product configured to receive a unit load 28 of a food commodity. The tracking device 10 includes at least one sensor 30 that is configured to track at least one environmental condition of an environment of the tracking device 10, and thus the unit load 28 of the food commodity, while the tracking device 10 is traveling along the food commodity supply chain in the conveyance structure 26. The sensor 30 may indicate when the environment of the food commodity is stable, as well as when an environmental condition falls outside a predetermined range that may compromise the quality and nutritional value of the food commodity.

The predetermined range may be provided by a user, such as a grower, distributor, purchaser, or a regulatory body with jurisdiction over the supply chain, as values of the predetermined range may differ according to the type of food commodity. Predetermined ranges for example food commodities are provided below in Table 1.

TABLE 1

| | Temperature | Humidity | Ethylene |
|---|---|---|---|
| Product | range (° F.) | range (%) | sensitivity |
| Apples | 30-40 | 90-95 | Yes |
| Avocados | 38-45 | 85-95 | Yes, very |
| Cocoa beans | 60-75 | 70-75 | No |
| Coffee beans | 65-75 | 50-65 | Yes |
| Mangos | 50-55 | 85-95 | Yes |
| Onions | 32-35 | 65-75 | No |
| Tangerines | 40-45 | 90-95 | No |
| Watermelon | 55-70 | 85-95 | Yes, very |

Further, it will be appreciated that these predetermined ranges may be combined using combinatorial logic functions that if met trigger the alert discussed herein to be transmitted. For example, each of a set of conditions may be required to be met, at least one of a set of conditions may be required to be met, or a subset of a set conditions may be required to be met prior to transmitting the alert, as some specific examples. Alternatively, instead of the determining whether the environmental value is within the predetermined range discussed herein, the system may be configured to detect whether the environmental value falls above a maximum threshold or falls below a minimum threshold for the value.

The tracking device 10 may additionally include an Inertial Measurement Unit (IMU) module 32 that is configured to determine IMU values of the tracking device 10, which may indicate a shift in position or load of the conveyance structure 26 to which the tracking device 10 is mounted. In some implementations, the conveyance structure 26 may be equipped with a pressure sensor 34 configured to measure a load placed on the conveyance structure 26, which may also indicate a shift in position or load of the conveyance structure 26. When multiple conveyance structures 26 are stacked, the pressure sensor 34 may be used to determine the position of the conveyance structure 26 in the stack, as a value of the pressure sensor 34 will detect a weight load placed on the conveyance structure 26 in addition to the unit load 28.

To minimize its carbon footprint, it is preferable for the tracking device 10 to be an ultralow-power device. To this end, the tracking device 10 may include a timer 36 to control power supplied to the tracking device 10 such that data from the sensor 30 is collected at specific time increments rather than continuously. The timer 36 may supply power to the tracking device 10 at a preprogrammed time or in preprogrammed periods. When powered on, the tracking device 10 collects data from the sensor 30, including an environmental value of the environment of the tracking device 10. Data from the IMU module 32 may also be collected at this time. Once collected, the data 38 from the tracking device 10 may be transmitted by a transceiver 40 included in the tracking device 10, and the timer 36 may be configured to cut power to the tracking device 10 until the next data collection timepoint. To further minimize power usage, the tracking device 10 may be configured to communicate according to Bluetooth Low Energy (BLE) standards, for example. Additionally or alternatively, the tracking device 10 may be configured to transmit data without a battery or power source via Radio Frequency (RF) backscatter, for example. Accordingly, the transceiver 40 may be configured as a BLE module and/or an RF backscatter module.

In some implementations, the tracking device 10 includes a passive radio frequency (RF) tag that is configured to emit a tracking signal when bombarded by radio waves from an interrogating RF transceiver. The RF tag may be configured as an RF identification (RFID) tag 42 that emits a unique tag identifier, for example. The passive RF tag 42 enables identification of the tracking device 10 as it travels along the supply chain. In addition to the identification of the tracking device 10, the RFID tag 42 may be configured to emit values from one or more sensors 30, such as a temperature sensor, for example.

The tracking device data 38, including data from the sensor 30 and the IMU module 32, as well as the identification of the tracking device 10, may be transmitted from the tracking device 10 to a communication hub 44 included in the tracking system 100. The communication hub 44 may be installed in a vehicle, such as a truck, ship, or airplane, for example, that is used to transport the food commodity along the supply chain. Additionally or alternatively, the communication hub 44 may be located in a storage facility or a warehouse at which the food commodity is temporarily held as it moves along the supply chain. The communication hub 44 is configured to receive the tracking device data 38 via a transceiver 46 included in the communication hub 44. Like the transceiver 40, the transceiver 46 may be configured to communicate via BLE standards and/or RF backscatter, for example. When configured to include an RF module, the transceiver 46 may function as the interrogating RF transceiver for the RFID tag 42 on the tracking device 10. Once received, the tracking device data 38 may be stored at the communication hub 44 in memory 48. In some implementations, the communication hub 44 may be configured as an edge computing device that is capable of performing elementary computational functions on the tracking device data 38.

To transmit the tracking device data 38 to the server computing device 14, the communication hub 44 may include device-side network components 50 configured to communicate with network signal stations 52 to enable a wireless communication network. For satellite-enabled communication, the communication hub 44 includes a Satellite Communications (SATCOM) module 54 that exchanges signals with satellites 56. For terrestrial-enabled communication, the communication hub includes a terrestrial communications module 58 configured to communicate with terrestrial access points 60. The terrestrial communications module 58 may be configured to communicate according to Long Term Evolution (LTE), Long Range (LoRa), or Television White Space (TVWS) standards, for example. Accordingly, the terrestrial access points may be respectively configured as cell towers, LoRa signal stations, or TVWS base stations. To determine whether to implement satellite-enabled communication or terrestrial-enabled communication, the communication hub 44 may further include a signal strength sensor 62. According to signal strength and conditions, the communication hub 44 is configured to switch between the SATCOM module 54 and the terrestrial communications module 58 via a signal switch module 64.

The device-side network components 50 and the network signal stations 52 are additionally included in a location determination subsystem 66 configured to determine a location of the tracking device 10 as it travels along the food commodity supply chain. The location determination subsystem 66 includes at least one of the SATCOM module 54 and the terrestrial communications module 58, and is configured to switch between the two modules 54, 58 according to the signal conditions determined by the signal strength sensor 62. The SATCOM module includes a Global Satellite Positioning (GPS) element configured to determine GPS coordinates of the tracking device 10. The location data 68 collected by the location determination subsystem 66 may be transmitted to the server computing device 14, along with the tracking device data 38, via a network 70 established by the device-side network components 50 and the network signal stations 52.

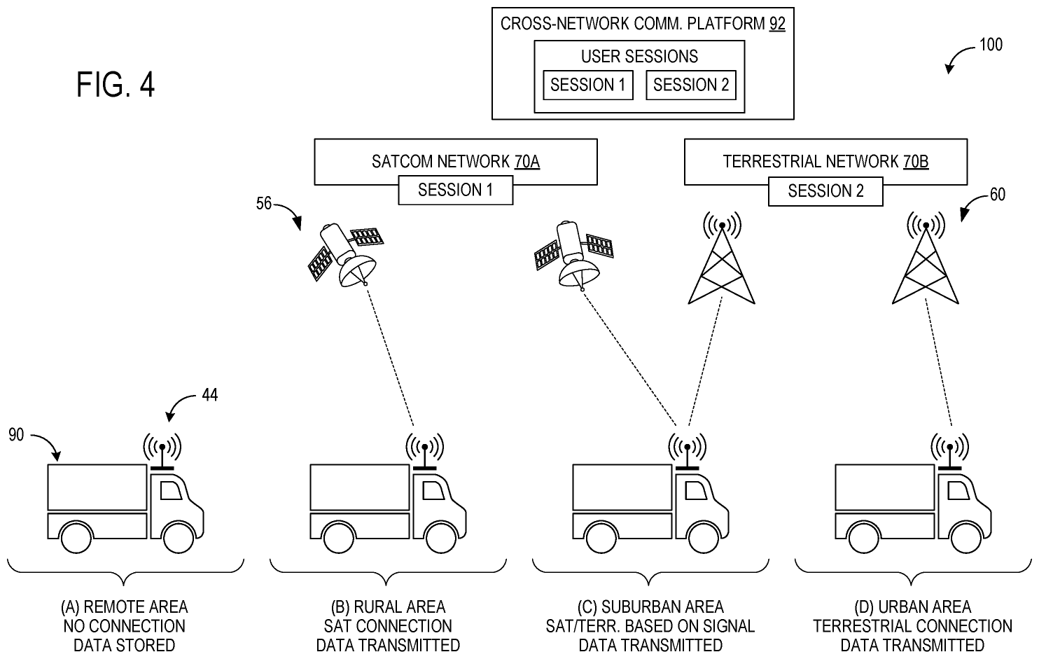

The server computing device 14 has at least one processor 18, which is configured to execute a sensor data analysis module 72. The sensor data analysis module 72 of the processor 18 is configured to receive the tracking device data 38 from the communication hub 44, including the environmental value of the environmental condition sensed by the sensor 30. The processor 18 then processes the environmental value to determine whether the environmental condition is within a predetermined environmental range. If the environmental condition falls outside the predetermined environmental range, i.e., falls above a maximum threshold or falls below a minimum threshold, the processor 18 is configured to transmit an alert 74 to the client computing device 16. The alert 74 is transmitted to the client computing device 16 via the network 70 and displayed via a user interface 76 on a display 78 of the client computing device 16. As discussed in detail below with reference to FIG. 4, the alert 74 may include a suggested interventive action 80 based on the environmental condition that falls outside the predetermined environmental range.

Upon receiving the IMU values of the tracking device 10 included in the tracking device data 38, the processor 18 may also execute an IMU data analysis module 82 to process the IMU values to determine whether the IMU values are within a predetermined IMU range. As with the environmental condition, if the IMU values fall outside the predetermined IMU range, the processor 18 is configured to transmit the alert 74 to the client computing device 16.

As described above, the location data 68 collected by the location determination subsystem 66 may be transmitted to the server computing device 14 along with the tracking device data 38. Accordingly, the processor 18 may execute a location data analysis module 86 to determine a location 88 of the communication hub 44 that is associated with the tracking device 10. The location 88 of the communication hub 44 may be transmitted to the client computing device 16 and displayed on the user interface 76, as the suggested interventive action 80 may include be to moving the food commodity contained in the conveyance structure 26 from its current location 88 to a different location (i.e., out of storage), changing the position of the unit load 28 of the affected food commodity with respect to other unit loads, adjusting the environment of the transportation vehicle, and/or rerouting the unit load 28 of the food commodity to an alternate destination.

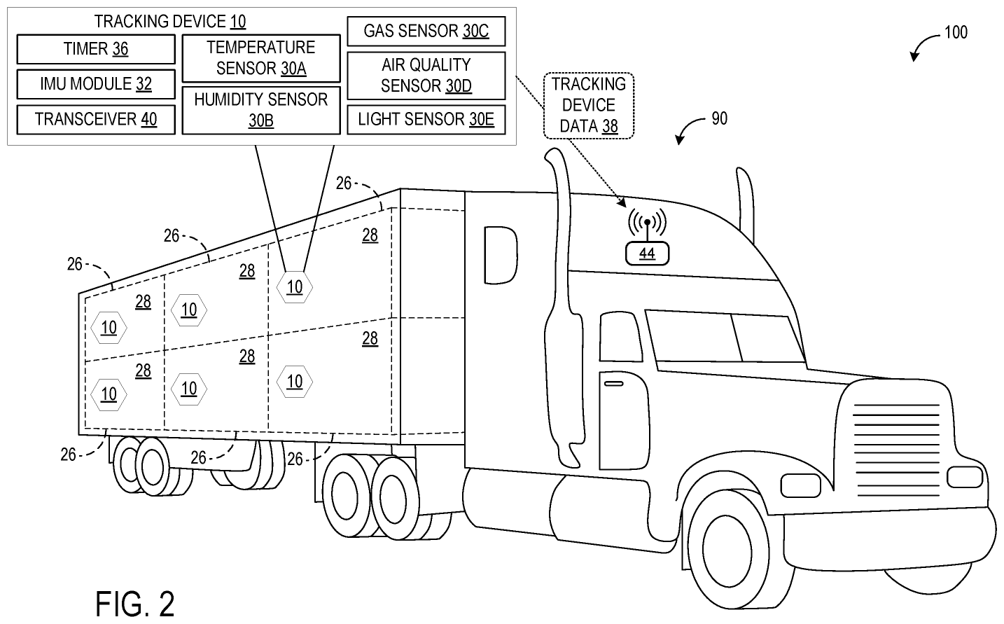

FIG. 2 illustrates an example implementation of the tracking system 100. As described above, the tracking device 10 is configured to be mounted to the conveyance structure 26 that stores or transports a unit load 28 of a food commodity traveling along the food commodity supply chain. Typically, a plurality of conveyance structures 26 carrying unit loads 28 of the same or similar commodity are transported together. In the example shown in FIG. 2, six conveyance structures 26 are moving along the supply chain on a truck 90. It will be appreciated that the conveyance structures 26 may alternatively be transported by a different type of vehicle, such as a ship, airplane, forklift, bicycle, electric vehicle, for example. The conveyance structures 26 may also be temporarily held at a storage facility or warehouse as they move along the supply chain.

As shown in FIG. 2, a respective tracking device 10 is mounted to each conveyance structure 26. Each tracking device 10 includes at least one sensor 30 configured to track an environmental condition of an environment of the tracking device 10, and thus the unit load 28 of the food commodity, while the tracking device 10 is traveling along the food commodity supply chain in the conveyance structure 26. In a typical implementation, the tracking device 10 will include a plurality of sensors 30, such as a temperature sensor 30A, humidity sensor 30B, gas sensor 30C, air quality sensor 30D, and light sensor 30E, for example. It will be appreciated that the sensor types listed are merely examples, and that other types of sensors may be included in the tracking device 10.

The sensors 30 are configured to indicate changes in environmental conditions that could be detrimental to the quality and nutritional value of the food commodity as it travels along the supply chain. For example, the temperature sensor 30A may detect whether the temperature is too high or too low, which can impact the taste and texture of product, as well as cause spoilage of the product if it undergoes repeated heating and cooling cycles. Certain temperatures also increase the risk of microbial growth and contamination, such as E. coli and Salmonella in produce, which may lead to widespread recalls and large amounts of food waste. The humidity sensor 30B may detect changes in humidity of the environment of the food commodity, which may impact the quality and nutritional value of the product.

A gas sensor 30C can be used to measure levels of gases such as ethylene (C₂H₄), carbon dioxide (CO₂), and volatile organic compounds (VOCs). Several types of fruits and vegetables produce C₂H₄ to initiate the ripening process. However, high levels of C₂H₄ may lead to premature ripening and damage to produce. Many fruits produce CO₂ as they ripen, which slows the ripening process and may cause the fruit to fail to ripen properly. Additionally, high levels of CO₂ may impact the flavor and texture of produce, leading to an undesirable product. Post-harvest ripening and/or sprouting, microbial contamination, and changes in environmental conditions may lead to alterations in the typical VOC profile of produce. As such, levels of VOCs may be used to indicate a quality or stress condition of produce.

Similar to the gas sensor 30C, the air quality sensor 30D can detect when air in the environment has an increased level of pollutants, such as smoke and fine particulate matter, as well as concentrations of ground level ozone, carbon monoxide, sulfur dioxide, and nitrogen dioxide, for example. Airborne pollutants may affect the quality of produce, as well as the health of consumers who ingest potentially dangerous chemicals deposited on the outside of produce products as a result of poor air quality.

The light sensor 30E can be used to determine whether a container that is configured to remain closed during transit was opened at any point. The light sensor 30E may additionally provide information regarding prolonged light or dark conditions of the conveyance structure 26 to which the tracking device 10 is mounted, which can have an impact on how quickly or slowly produce ripens.

Tracking device data 38, including data from the sensors 30 and the IMU module 32, as well as the identification of the tracking device 10, may be transmitted from the tracking device 10 to the communication hub 44 installed in the truck 90. As described in detail above, the communication hub may send the tracking device data 38 to the server computing device 14 for analysis.

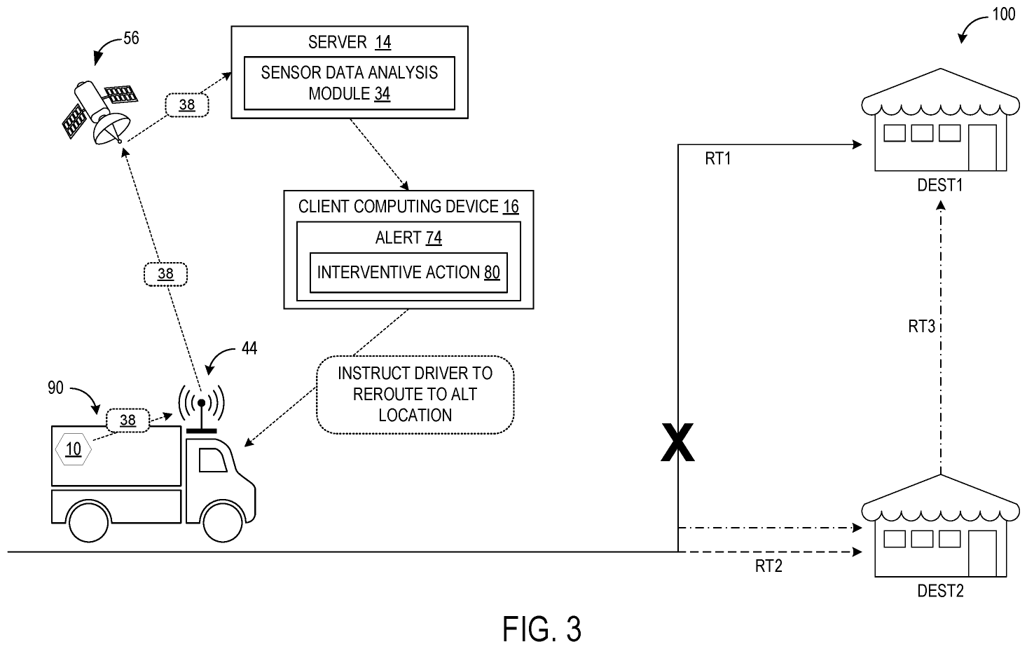

FIG. 3 shows an example scenario in which the tracking system 100 is implemented in a food supply chain. The food commodity traveling along the supply chain may be a produce product, such as apples, for example. As described above with reference to FIG. 2, the tracking device 10 is mounted to a conveyance structure 26 that is being transported by the truck 90. The tracking device data 38 is transmitted from the tracking device 10 to the communication hub 44 installed in the truck 90. In the illustrated example, the communication hub 44 transmits the tracking device data 38 to the server computing device 14 via a satellite-enabled communication network. However, it will be appreciated that the communication hub 44 may alternatively transmit the tracking device data 38 to the server computing device 14 via a terrestrial-enabled communication network. The processor 18 executes the sensor data analysis module 72 and determines that at least one environmental value falls outside the predetermined environmental range. In the example provided, the temperature and C₂H₄ levels may be higher than the limits needed to maintain the freshness, quality, and nutritional value of the apples. The server computing device 14 transmits an alert 74 to the client computing device 16, which is displayed via the user interface 76 on the display 78. As described above, the alert 74 may include a suggested interventive action 80. In the example scenario, the apples may be ripening too quickly as a result of the increased temperature and C₂H₄ levels. As such, the suggested interventive action 80 may be to redirect the apples to an alternate destination DEST2 that is closer than the original destination DEST1. The interventive action 80 is communicated to the driver of the truck 90, who cancels a first route RT1 to DEST1, indicated by the solid line with an “X”, and instead delivers the apples to DEST2 on a second route RT2 indicated by the dashed line. By rerouting in accordance with the unfavorable environmental conditions detected by the sensors 30, the availability of the apples in a marketplace is expedited, thereby preventing loss of the apples and enhancing sustainability of the food commodity supply chain.

In some implementations, conveyance structures 26 may be routed independently of each other based on the conditions experienced by each conveyance structure 26. For example, only a subset of (e.g., only one or a few of) conveyance structures 26 in a single vehicle load may experience environmental conditions that fall outside the predetermined environmental range, while the remaining conveyance structures 26 in the load do not. When this occurs, the affected conveyance structures 26 may be delivered to DEST2, as indicated by the dash-dot line, and the rest of the conveyance structures 26 on the truck 90 may continue on to DEST1 on a third route RT3. Additionally or alternatively, the affected conveyance structures 26 may be taken off the truck 90 at a central hub or storage facility, and placed on a different truck to be delivered to a closer location, such as DEST2, thereby resulting in a reconfigurable produce supply chain. The position of the affected conveyance structures 26 may be determined by the load on the respective pressure sensor 34, as well as identifying, via respective RFID tags 42, which tracking devices 10 sensed the outlying environmental conditions. Similarly, when a tracking device 10 mounted to a conveyance structure 26 at a storage facility or warehouse senses unfavorable environmental conditions for the unit load 28 of the food commodity, that conveyance structure may be tagged for expedited transit. In this manner, route planning decisions for each conveyance structure 26 may be made based on the environmental conditions experienced by that conveyance structure 26.

As described above with reference to FIG. 1, the communication hub 44 includes at least one of the SATCOM module 54 and the terrestrial communications module 58, and is configured to switch between the SATCOM module 54 and the terrestrial communications module 58 in accordance with signal conditions. FIG. 4 is an illustration of this hybrid network connectivity of the tracking system 100, using a cross-network communication platform 92. In panel (A) of FIG. 4, the truck 44 is depicted as traveling through a remote area in which no network connectivity is available. When the communication hub 44 is not able to establish a network connection with a satellite 56 and/or a terrestrial access point 60, the tracking device data 38 is stored in the memory 48 of the communication hub 44. As the truck 90 travels through a rural area, network connectivity may be established between the SATCOM module 54 and at least one satellite 56, as shown in panel (B). When the communication hub 44 and the satellite 56 are connected via a satellite-enabled communication network 70A, user session 1 may be initiated. When the truck 90 reaches a suburban area, as shown in panel (C), the communication hub 44 may be able to connect to both satellites 56 and terrestrial access points 60. The signal strength sensor 62 may determine if the signal between the SATCOM module 54 and the satellite 56 or the signal between the terrestrial communications module 58 and the terrestrial access point 60 is stronger, and activate the signal switch module 64 to switch to the network with the strongest signal. When the communication hub 44 and at least terrestrial access point 60 are connected via a terrestrial-enabled communication network 70B, user session 2 may be initiated. The cross-network communication platform 92 facilitates the transfer of data as the communication hub 44 switches from the satellite-enabled communication network 70A to the terrestrial-enabled communication network 70B such that the transition from user session 1 to user session 2 is seamless. In the illustrated example, the terrestrial-enabled communication network 70B is configured to use BLE standards to facilitate communication between a BLE module and cell towers. However, it will be appreciated that the terrestrial-enabled communication network 70B may alternatively be configured for communication according to LoRa or TVWS standards, as described above. In some implementations, when the terrestrial communication module 58 is configured as a LoRa module, the LoRa module may exchange signals with Internet of Things (IoT) satellites configured to communicate in the LoRa band, in addition to LoRa signal stations.

FIG. 5 is a schematic diagram of a tracking system 200 for a food commodity supply chain according to a second embodiment. The tracking system 200 is substantially the same as the tracking system 100 described above with reference to FIG. 1, and like reference numbers are used to depict common components. In tracking system 200, the first computing device is configured as a microcontroller unit (MCU) 214 included in the tracking device 10. Like the server computing device 14, the MCU 214 includes a processer 218 that executes the sensor data analysis module 72 and the IMU data analysis module. The sensor data analysis module 72 of the processor 218 is configured to receive the environmental value of the environmental condition sensed by the sensor 30. The processor 218 then processes the environmental value to determine whether the environmental condition is within the predetermined environmental range. If the environmental condition falls outside the predetermined environmental range, the processor 218 is configured to transmit an alert 274 to the communication hub 44, which is then communicated to the client computing device 16. As with the environmental condition, IMU values from the IMU module 32 are processed to determine if they fall outside the predetermined IMU range. If the IMU values fall outside the predetermined IMU range, the processor 218 is configured to transmit the alert 274 to the communication hub 44, which is then communicated to the client computing device 16.

In the tracking system 200, location data 68 is collected by the location determination subsystem 66. However, the location data analysis module 286 is included in the processor 222 of the client computing device 16. As such, the location 88 of the communication hub 44 is determined at the client computing device 16 in the tracking system 200, and subsequently displayed on the user interface 76 via the display 78.

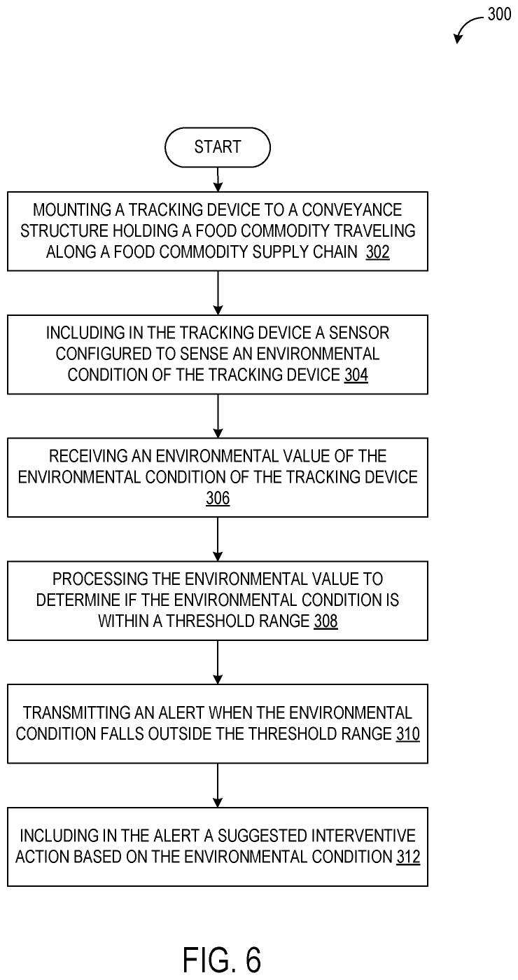

FIG. 6 is a flowchart of a method 300 for tracking a food commodity through a supply chain according one example configuration of the present disclosure. At step 302, the method 300 may include mounting a tracking device to a conveyance structure configured to receive a food commodity. As described in detail above, the conveyance structure may hold a unit load of a food commodity as it travels along the food commodity supply chain.

Continuing from step 302 to step 304, the method 300 may include including in the tracking device at least one sensor. The sensor may be configured to sense an environmental condition of the tracking device, and thus the food commodity, as it travels along the supply chain. The sensor may be configured as a temperature sensor, humidity sensor, gas sensor, air quality sensor, or light sensor, for example, and the tracking device may include more than one type of sensor.

Advancing from step 304 to step 306, the method 300 may include receiving, from the at least one sensor, the environmental value of the at least one environmental condition of the tracking device. At 308, the method may include processing the environmental value to determine whether the at least one environmental condition is within a predetermined range. Changes in conditions such as temperature, humidity, air quality, light, and exposure to gases can lead to changes in flavor or texture of the produce, as well as expedited ripening.

Continuing from step 308 to step 310, the method 300 may include, transmitting an alert when the at least one environmental condition falls outside the predetermined range. At 312, the method may include including in the alert a suggested interventive action based on the at least one environmental condition that falls outside the predetermined environmental range. As described above, the suggested interventive action may be to move the food commodity out of storage, change the position of the unit load of the affected food commodity with respect to other unit loads, adjusting the environment of the transportation vehicle, and/or reroute the food commodity during transit such that the quality and nutritional value of the food commodity is preserved and food loss is minimized.

The quality and freshness of food products is of high importance to consumers. When food products, especially perishable products such as produce, arrive at the marketplace in subpar conditions, these products may be priced and distributed differently than products that arrive at the peak of freshness. Additionally, a decline in quality of food products as they travel along the food commodity supply chain can lead to great quantities of food waste. The tracking systems 100, 200 and the method 300 described herein provide mechanisms for tracking the environmental conditions of food commodities as they move along the supply chain. This system enables the quality of the food commodities to be monitored at regular intervals, which permits users to take interventive actions that preserve the freshness of the food commodities and prevent spoilage and waste. Additionally, food commodities that are identified as having microbial contamination can be traced, such that the contaminated products and potential spread of the microorganism is contained. The system of the present disclosure utilizes compact tracking devices and communication systems that are low power, yet capable of transferring information that can be used to preserve the quality and nutritional value of food products as they travel along the food commodity supply chain. Such a technical solution is low cost, scalable, and provides environmental information about food commodities with sufficient accuracy to meet the needs of supply chain sustainability and accountability.

In some embodiments, the methods and processes described herein may be tied to a computing system of one or more computing devices. In particular, such methods and processes may be implemented as a computer application program or service, an application-programming interface (API), a library, and/or other computer program product.

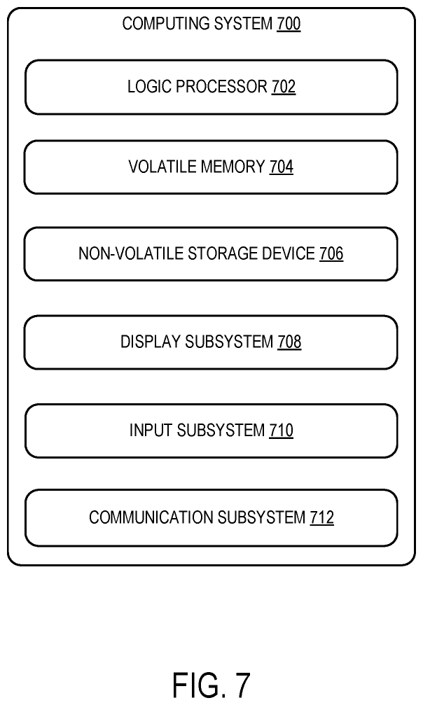

FIG. 7 schematically shows a non-limiting embodiment of a computing system 700 that can enact one or more of the methods and processes described above. Computing system 700 is shown in simplified form. Computing system 700 may embody the computing devices 14 and/or 16 described above and illustrated in FIG. 1. Computing system 700 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed, e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 700 to send and/or receive messages to and/or from other devices via a network such as the Internet.

The following paragraphs provide additional description of aspects of the present disclosure. One aspect provides a tracking system for a food commodity supply chain. The tracking system may comprise a tracking device and at least one computing device having at least one processor. The tracking device may be configured to be mounted to a conveyance structure configured to receive a unit load of a food commodity traveling along the food commodity supply chain. The tracking device may include at least one sensor configured to track at least one environmental condition of an environment of the tracking device while the tracking device is traveling along the food commodity supply chain. The at least one processor may be configured to execute instructions using portions of associated memory to receive an environmental value of the at least one environmental condition sensed by the at least one sensor, process the environmental value to determine whether the at least one environmental condition is within a predetermined environmental range, and transmit an alert when the at least one environmental condition falls outside the predetermined environmental range. The alert may include a suggested interventive action based on the at least one environmental condition that falls outside the predetermined environmental range.

In this aspect, additionally or alternatively, the tracking system may further comprise a communication hub configured to receive, store, and transmit data from the tracking device. The communication hub may include at least one of a Satellite Communications (SATCOM) module and a terrestrial communications module, and the communication hub may be configured to switch between the SATCOM module and the terrestrial communications module in accordance with signal conditions.

In this aspect, additionally or alternatively, the tracking system may further comprise a location determination subsystem configured to determine a location of the tracking device as it travels along the food commodity supply chain. The location determination subsystem may include at least one of a SATCOM module and a terrestrial communications module. The SATCOM module may include a Global Satellite Positioning (GPS) element configured to determine GPS coordinates of the tracking device, and the terrestrial communications module is configured to exchange signals with local cellular towers.

In this aspect, additionally or alternatively, the tracking device may include an Inertial Measurement Unit (IMU) module configured to determine IMU values of the tracking device. The at least one processor may be further configured to receive IMU values of the tracking device, process the IMU values to determine whether the IMU values are within a predetermined IMU range, and transmit an alert when the IMU values fall outside the predetermined IMU range.

In this aspect, additionally or alternatively, the at least one sensor may be selected from the group consisting of temperature sensor, humidity sensor, gas sensor, air quality sensor, and light sensor. The system may include at least one pressure sensor configured to measure a load placed on the conveyance structure.

In this aspect, additionally or alternatively, the tracking device may be enabled for wireless communication according to Bluetooth Low Energy (BLE) standards or Radio Frequency (RF) backscatter.

In this aspect, additionally or alternatively, the food commodity may be produce, and the environment condition may indicate a reduction in shelf-life of the produce. The suggested interventive action may be to redirect the produce to an alternate destination closer than an original destination such that its availability in a marketplace is expedited, thereby preventing loss of the produce and enhancing sustainability of the food commodity supply chain.

In this aspect, additionally or alternatively, the conveyance structure may be one of a plurality of conveyance structures traveling along the food commodity supply chain on a vehicle, and a respective tracking device may be mounted to each conveyance structure of the plurality of conveyance structures.

Another aspect provides a method for tracking a food commodity through a supply chain. The method may comprise receiving, from at least one sensor, an environmental value of at least one environmental condition of a tracking device traveling along the food commodity supply chain, the tracking device being mounted to a conveyance structure holding a unit load of a food commodity. The method may further comprise processing the environmental value to determine whether the at least one environmental condition is within a predetermined environmental range, and transmitting an alert when the at least one environmental condition falls outside the predetermined environmental range. The alert may include a suggested interventive action based on the at least one environmental condition that falls outside the predetermined environmental range.

In this aspect, additionally or alternatively, the method may further comprise receiving, at a communication hub, data from the tracking device, storing, at the communication hub, data from the tracking device, and transmitting, from the communication hub, data from the tracking device. The method may further comprise including in the communication hub at least one of a SATCOM module and a terrestrial communications module, and switching, by the communication hub, between the SATCOM module and the terrestrial communications module in accordance with signal conditions.

In this aspect, additionally or alternatively, the method may further comprise determining, by a location determination subsystem, a location of the tracking device as it travels along the food commodity supply chain. The location determination subsystem includes at least one of a SATCOM module and a terrestrial communications module. The SATCOM module may include a Global Satellite Positioning (GPS) element configured to determine GPS coordinates of the tracking device, and the terrestrial communications module is configured to exchange signals with local cellular towers.

In this aspect, additionally or alternatively, the method may further comprise determining, by an Inertial Measurement Unit (IMU) module included in the tracking device, IMU values of the tracking device. The method may further comprise receiving IMU values of the tracking device, processing the IMU values to determine whether the IMU values are within a predetermined IMU range, and transmitting an alert when the IMU values fall outside the predetermined IMU range.

In this aspect, additionally or alternatively, the at least one sensor may be selected from the group consisting of temperature sensor, humidity sensor, gas sensor, air quality sensor, and light sensor.

In this aspect, additionally or alternatively, the method may further comprise measuring, by at least one pressure sensor, a load placed on the conveyance structure.

In this aspect, additionally or alternatively, the method may further comprise enabling the tracking device for wireless communication according to Bluetooth Low Energy (BLE) standards or Radio Frequency (RF) backscatter.

In this aspect, additionally or alternatively, the food commodity may be produce. The method may further comprise determining the environment condition is indicative of a reduction in shelf-life of the produce, and redirecting the produce to an alternate destination closer than an original destination such that its availability in a marketplace is expedited, thereby preventing loss of the produce and enhancing sustainability of the food commodity supply chain.

Another aspect provides a tracking system for a food commodity supply chain. The tracking system may comprise a plurality of conveyance structures, a communication hub, and at least one computing device having at least one processor. Each conveyance structure may be configured to receive a unit load of a food commodity traveling along the food commodity supply chain, and each conveyance structure may have a respective tracking device mounted thereto. Each respective tracking device may include a sensor configured to track an environmental condition of an environment of the respective tracking device while the respective tracking device is traveling along the food commodity supply chain. The communication hub may be configured to receive and transmit data from each respective tracking device. The at least one processor may be configured to execute instructions using portions of associated memory to receive, from the communication hub, an environmental value of the environmental condition sensed by the sensor, process the environmental values to determine whether each of the environmental conditions is within a predetermined environmental range, and transmit an alert when one or more of the environmental conditions falls outside the predetermined environmental range. The alert may include a suggested interventive action based on the one or more environmental condition that falls outside the predetermined environmental range. The communication hub may include at least one of a SATCOM module and a terrestrial communications module. The communication hub may be configured to switch between the SATCOM module and the terrestrial communications module in accordance with signal conditions. In the absence of a network connection, the communication hub may store the data from each respective tracking device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A tracking system for a food commodity supply chain, the tracking system comprising:
a tracking device configured to be mounted to a conveyance structure configured to receive a unit load of a food commodity traveling along the food commodity supply chain, the tracking device including at least one sensor configured to track at least one environmental condition of an environment of the tracking device while the tracking device is traveling along the food commodity supply chain; and
at least one computing device having at least one processor configured to execute instructions using portions of associated memory to:
receive an environmental value of the at least one environmental condition sensed by the at least one sensor,
process the environmental value to determine whether the at least one environmental condition is within a predetermined environmental range, and
transmit an alert when the at least one environmental condition falls outside the predetermined environmental range, wherein
the alert includes a suggested interventive action based on the at least one environmental condition that falls outside the predetermined environmental range.

2. The tracking system of claim 1, further comprising:
a communication hub configured to receive, store, and transmit data from the tracking device, wherein
the communication hub includes at least one of a Satellite Communications (SATCOM) module and a terrestrial communications module, and
the communication hub is configured to switch between the SATCOM module and the terrestrial communications module in accordance with signal conditions.

3. The tracking system of claim 1, further comprising:
a location determination subsystem configured to determine a location of the tracking device as it travels along the food commodity supply chain, wherein
the location determination subsystem includes at least one of a SATCOM module and a terrestrial communications module,
the SATCOM module includes a Global Satellite Positioning (GPS) element configured to determine GPS coordinates of the tracking device, and
the terrestrial communications module is configured to exchange signals with local cellular towers.

4. The tracking system of claim 1, wherein
the tracking device includes an Inertial Measurement Unit (IMU) module configured to determine IMU values of the tracking device.

5. The tracking system of claim 4, wherein
the at least one processor is further configured to:
receive IMU values of the tracking device,
process the IMU values to determine whether the IMU values are within a predetermined IMU range, and
transmit an alert when the IMU values fall outside the predetermined IMU range.

6. The tracking system of claim 1, wherein
the at least one sensor is selected from the group consisting of temperature sensor, humidity sensor, gas sensor, air quality sensor, and light sensor.

7. The tracking system of claim 1, wherein
the system includes at least one pressure sensor configured to measure a load placed on the conveyance structure.

8. The tracking system of claim 1, wherein
the tracking device is enabled for wireless communication according to Bluetooth Low Energy (BLE) standards or Radio Frequency (RF) backscatter.

9. The tracking system of claim 1, wherein,
the food commodity is produce,
the environmental condition indicates a reduction in shelf-life of the produce, and
the suggested interventive action is to redirect the produce to an alternate destination closer than an original destination such that its availability in a marketplace is expedited, thereby preventing loss of the produce and enhancing sustainability of the food commodity supply chain.

10. The tracking system of claim 1, wherein
the conveyance structure is one of a plurality of conveyance structures traveling along the food commodity supply chain on a vehicle, and
a respective tracking device is mounted to each conveyance structure of the plurality of conveyance structures.

11. A method for tracking a food commodity through a supply chain, the method comprising:
receiving, from at least one sensor, an environmental value of at least one environmental condition of a tracking device traveling along the food commodity supply chain, the tracking device being mounted to a conveyance structure holding a unit load of a food commodity;
processing the environmental value to determine whether the at least one environmental condition is within a predetermined environmental range; and
transmitting an alert when the at least one environmental condition falls outside the predetermined environmental range, wherein
the alert includes a suggested interventive action based on the at least one environmental condition that falls outside the predetermined environmental range.

12. The method of claim 11, the method further comprising:
receiving, at a communication hub, data from the tracking device,
storing, at the communication hub, data from the tracking device,
transmitting, from the communication hub, data from the tracking device,
including in the communication hub at least one of a SATCOM module and a terrestrial communications module, and
switching, by the communication hub, between the SATCOM module and the terrestrial communications module in accordance with signal conditions.

13. The method of claim 11, the method further comprising:
determining, by a location determination subsystem, a location of the tracking device as it travels along the food commodity supply chain, wherein
the location determination subsystem includes at least one of a SATCOM module and a terrestrial communications module,
the SATCOM module includes a Global Positioning System (GPS) element configured to determine GPS coordinates of the tracking device, and
the terrestrial communications module is configured to exchange signals with local cellular towers.

14. The tracking system of claim 11, the method further comprising:
determining, by an Inertial Measurement Unit (IMU) module included in the tracking device, IMU values of the tracking device.

15. The method of claim 14, the method further comprising:
receiving IMU values of the tracking device;
processing the IMU values to determine whether the IMU values are within a predetermined IMU range; and
transmitting an alert when the IMU values fall outside the predetermined IMU range.

16. The method of claim 11, wherein
the at least one sensor is selected from the group consisting of temperature sensor, humidity sensor, gas sensor, air quality sensor, and light sensor.

17. The method of claim 11, the method further comprising:
measuring, by at least one pressure sensor, a load placed on the conveyance structure.

18. The method of claim 11, the method further comprising:
enabling the tracking device for wireless communication according to Bluetooth Low Energy (BLE) standards or Radio Frequency (RF) backscatter.

19. The method of claim 11, wherein,
the food commodity is produce, and
the method further comprises:
determining the environmental condition is indicative of a reduction in shelf-life of the produce, and
redirecting the produce to an alternate destination closer than an original destination such that its availability in a marketplace is expedited, thereby preventing loss of the produce and enhancing sustainability of the food commodity supply chain.

20. A tracking system for a food commodity supply chain, the tracking system comprising:
a plurality of conveyance structures, each conveyance structure being configured to receive a unit load of a food commodity traveling along the food commodity supply chain, each conveyance structure having a respective tracking device mounted thereto, each respective tracking device including a sensor configured to track an environmental condition of an environment of the respective tracking device while the respective tracking device is traveling along the food commodity supply chain;
a communication hub configured to receive and transmit data from each respective tracking device; and
at least one computing device having at least one processor configured to execute instructions using portions of associated memory to:
receive, from the communication hub, an environmental value of the environmental condition sensed by the sensor,
process the environmental values to determine whether each of the environmental conditions is within a predetermined environmental range, and
transmit an alert when one or more of the environmental conditions falls outside the predetermined environmental range, wherein
the alert includes a suggested interventive action based on the one or more environmental condition that falls outside the predetermined environmental range,
the communication hub includes at least one of a SATCOM module and a terrestrial communications module,
the communication hub is configured to switch between the SATCOM module and the terrestrial communications module in accordance with signal conditions, and
in the absence of a network connection, the communication hub stores the data from each respective tracking device.
